(19) United States
(12) Patent Application Publication
(10) Pub. No.: US 2025/0061169 A1
(43) Pub. Date: Feb. 20, 2025

(54) Grid Sampling Methodologies in Neural Network Processor Systems

(71) Applicant: Expedera, Inc., Santa Clara, CA (US)

(72) Inventors: Jeff Xue, Dublin, CA (US); Siyad Ma, Palo Alto, CA (US); Shang-Tse Chuang, Los Altos, CA (US); Sharad Chole, San Jose, CA (US)

(21) Appl. No.: 18/452,022

(22) Filed: Aug. 18, 2023

(51) Int. Cl. G06F 17/16; G06T 3/60

(52) U.S. Cl. CPC G06F 17/16; G06T 3/60

(57) ABSTRACT

A system and method for performing tensor transforms on customized digital hardware. The system is comprised of a plurality of computational blocks, a control unit, and memory. The control unit is configured to read the generated source tensor slices for the generated indexes and read from memory the source tensor data and weight data interpolate the tensor slices based on the weights according to a transformation guide. The source tensor data and tensor weights are sent to multiple computational blocks for parallel generation of interpolated output tensor data. The data in memory can be configured so that only one address is needed to read multiple tensor dimensions or a tensor slice. Additionally, the memory can be configured to accept multiple memory addresses in parallel. The computational block output provides a grid-sampled output tensor.

### TECHNICAL FIELD

The present application relates to the field of specialized electronic processing hardware providing systems, devices, and methods for improved Grid Sampling and Image Transformation operations providing multiple interpolation operations in reduced clock cycles. These operations are commonly used in neural networks addressing motion and optic flows, feature maps, and other tensor transforms. In particular, but not by way of limitation, the present invention discloses semiconductor systems and methods for grid sampling in conjunction with tensor operators.

### BACKGROUND

It should not be assumed that any of the approaches described in this section qualify as prior art merely by virtue of their inclusion in this section. Grid sampling and tensor operators processing on a data set can require access to data not located sequentially in memory. Thus, the ability to pipeline access to the data and generate the grid samples is limited and can require many clock cycles to implement the desired tensor operator and grid sampling. What is needed are methods, neural processors, electronic systems, and structures that improve the efficiency of tensor transforms, including grid sampling when performed in conjunction with executing tensor operators.

### SUMMARY

This summary is provided to introduce a selection of concepts in a simplified form that is further described below in the Detailed Description of Example Embodiments. This summary is not intended to identify key features or essential features of the claimed subject matter, nor is it intended to be used as an aid in determining the scope of the claimed subject matter.

In one aspect of the disclosure pertains to methods for performing spatial tensor transforms on a customized digital processor unit. In one embodiment, the spatial tensor transforms are methods that include determining source tensor slices required for each index according to a transformation guide. A single memory address is determined for the source tensor slices for each index. The memory address is used to load the source tensor slice memory addresses for each index in the transformation guide.

An output tensor slice is generated based on the interpolation of the source tensor slices for each index. The interpolation is based on information in the transformation guide, including interpolation weights and the type of interpolation to be used.

In one embodiment, the source tensor slice is read from the memory using a single memory address. The slices in memory are organized so that only the starting address of a slice needs to be known, and the rest of the slice can be read at a known offset in memory. In a further embodiment, a plurality of values from the source tensor slice is read in a single pipeline cycle. Further, the loaded source tensor for interpolation can be through a cache. The interpolation of the indexes can include various spatial transforms, including rotation, scaling, up-sampling, down-sampling, perspective, and distortion operations. The interpolation can include linear, bilinear, cubic, and N-dimensional interpolation.

In another embodiment described herein, a system for performing tensor transform on customized digital hardware is described. The system includes a number of computational blocks. The computational blocks calculate index values for a tensor transform or tensor operator. Further, the computational blocks can generate the weights for the interpolation of the tensor slices to generate an output tensor. The index and interpolation weight information can be stored in a transformation guide. The tensor transforms or operators can include spatial transforms including but not limited to rotation, scaling, up-sampling, down-sampling, perspective, and distortion operations. The source tensor slices can be comprised of a plurality of pixels in one or more dimensions.

The system can include a memory subsystem where a source tensor slice can be read using a single memory address. Further, the memory subsystem can simultaneously receive multiple memory addresses and provide data for multiple source slices.

### BRIEF DESCRIPTION OF THE DRAWINGS

Exemplary embodiments are illustrated by way of example and not limited by the figures of the accompanying drawings, in which like references indicate similar elements.

FIG. 1—Is an example of a two-dimensional tensor showing the relationship between a tensor transform and a second two-dimensional tensor after a rotation operation.

FIG. 2A—Is an example of a two-dimensional tensor and interpolation of a tensor slice to generate an output.

FIG. 2B—Is an example of a two-dimensional multi-channel tensor and a second two-dimensional tensor after a rotation operator.

FIG. 3—Is an example of a system for performing tensor operation on multi-dimensional tensors.

FIG. 4—Is a is a flowchart for providing a method for performing a tensor transform.

### DETAILED DESCRIPTION OF EXAMPLE EMBODIMENTS

The following detailed description includes references to the accompanying drawings, which are a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, functional, logical, and electrical changes can be made without departing from the scope of what is claimed. The following detailed description is, therefore, not to be taken in a limiting sense, and the scope is defined by the appended claims and their equivalents.

A tensor is a container that can house data in N dimensions. A tensor can also be defined as a multi-dimensional matrix of numbers. A two-dimensional array can represent the pixels of an image. A three-dimensional array can represent a volume. Often and erroneously used is the use of tensor interchangeably with a matrix (which is specifically a 2-dimensional tensor). Tensors are generalizations of matrices to N-dimensional spaces. One example of a tensor is a two-dimensional array that represents image pixels in a two-dimensional coordinate system at distinct points.

Tensor operators can generate a request for data that does not lie on a distinct point within a source tensor or source tensor array. Thus, to minimize the artifacts caused by requesting data not lying on a discrete data point within a source tensor array, data within the source tensor can be interpolated to estimate the output tensor resulting from the tensor operator.

Associated with the tensor operation is a transformation guide. The transformation guide contains information about which dimensions of the tensor are subject to a tensor operator. Additionally, the transformation guide includes information for creating the transformation of the source tensor to a transformed tensor. These values are referred to as the index values. Further, the transformation guide includes information regarding an N-dimensional space of interest to be processed. For a two-dimensional space, the space is an area that can be an image. The transformation guide, also referred to as the guide, can be a data structure or an array of information. A slice is a continuous subset of a tensor.

In some embodiments, there is more than one transformation guide for the source slices required to generate an output slice. In some embodiments, there is a guide for each source slice or a guide for each output slice, or a single guide for the entire output.

A guide can range in its contents. In the simplest form, a guide could contain the coordinates of the source area and the tensor operator to be performed. For example, a down-sampling tensor operator does not generate any index values that need to be grid sample interpolated. Thus, a guide for a down-sampling tensor transformation does not need indexes or grid weights for interpolation. In another embodiment, the guide can contain information about the tensor transform to be executed, the dimension and dimension ranges to be used in the tensor transform, the indexes for one or more source slices, and calculated grid sample weights for the indexes.

Spatial transformation can include the modification of certain dimensions and can modify the dimensionality of a tensor. Note, that the dimensionality of the tensor does not have to be modified. Some dimensions can be kept constant, while on other dimensions, a spatial transform is being performed. This can include modifying the dimensionality or transforming the pixels into some other pixels. For example, a tensor comprising multiple channels and includes warping the tensor with a spatial transform. This is the mapping from one coordinate space to another coordinate space. This can include motion compensation, rotation, upscaling, and downscaling, which can be considered a coordinate transform. Every destination slice depends on at least one source slice. Spatial transformation is coordinate remapping. Grid sampling is not a coordinate transformation but coordinate realignment.

The process involves two steps. First, a determination of all the input tensor slices required to generate a destination slice is computed. Secondly, these input tensor slices are interpolated to generate the destination slice. The interpolation can be linear, bi-cubic, bi-linear, tri-linear, or any other interpolation. Some indexes can be common across a transformation, and some indexes are calculated across transformations. A guide provides a mapping of which input pixels are used in determining an output pixel.

A slice is a continuous subset of a tensor. Parallelization of the data can increase with the serialization of the data in memory. The guide provides information on the index memory location.

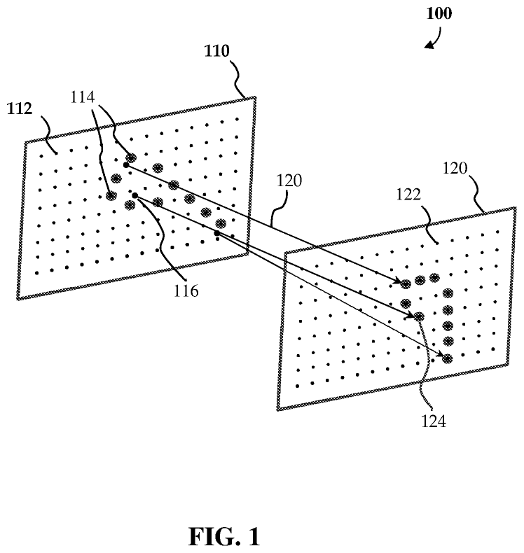

FIG. 1 is a depiction 100 of a source two-dimensional tensor 110 being transformed to a two-dimensional output tensor 120. In the shown example, the two-dimensional tensor 110 can be an image where each point 114 represents a pixel value. The tensor operation shown maps the source tensor 110 to the output tensor 120 in a rotation operation. In the shown example, the value “9” is rotated into an upright orientation. It can be advantageous to rotate the image for further processing by a system. For example, the source image could be a face and the rotation could be to rotate the face into a standard orientation to provide faster or increased accuracy in facial recognition.

While the pixels 114 that form the “9” in the source tensor 110 are shown as being distinctive from the surrounding pixels, the surrounding pixels will typically have varying values that are useful for generating the output tensor 120. Thus, the indexes 116, for example, generated by the tensor operator, should be generated by interpolation of surrounding pixels. The output tensor value 124 can be the interpolation of the four pixels closest to index 116.

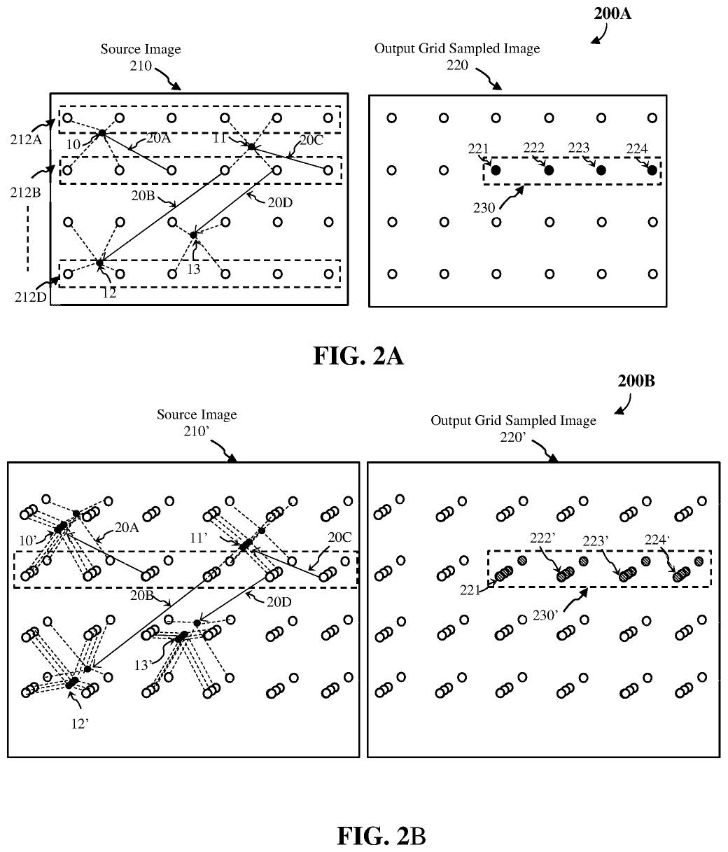

FIG. 2A provides an example 200A of how a two-dimensional source image 210 is processed by a tensor operator, and grid sampled to generate an output grid sampled image 220. An output slice 230 is related to one or more source slices 212A-212D. While the output slice 230 is shown to be the four values 221-224, the output slice 230 can include fewer or more values along a row. This is also true for source image 210. While the source slice 212A-212D shows six values in a source slice, the source slice 212A-212D can include more or fewer values in a source slice 212x. In this shown example, the one output slice 230 is dependent on four slices 212A-212D of the source image 210. Depending on the tensor transformation, fewer or more source slices can be required to generate the output slice 230.

The source slice 212A-212D index values 10-13 are used to generate the output slice 230 values 221-224 in the output tensor 220. These values can be precalculated. As shown in FIG. 2A, the index values 10-13 are the x and y points with the source image 210 from which the output image samples 221-224 are generated. Further, the four closest values to the index's x and y location are interpolated to generate the output grid values 221-224.

FIG. 2B provides an example 200B of how a multi-dimensional source image 210′ is processed by a tensor operator, and grid sampling is performed to generate a multi-dimensional output grid sampled image 220′. In the shown example 220B, the additional dimensions are channels associated with a source image 210′ pixel. An output slice 230′ is related to one or more source slices in the N-dimensional matrix. As shown, a source slice can include all of the channels within the associated slice. While the output slice 230′ is shown to be four values 221′-224′ and the values of the associated channels, the output slice 230′ can include fewer or more tensor values along a row or tensor dimension.

To improve the computation speed, the N-dimensional slices can be organized in memory where each associated channel value is at a known offset from the previous and next channel value. Thus, a hardware sequencer can be configured to quickly read a source slice data. In one hardware embodiment, the memory hardware can accept one or more memory addresses for parallel reading of source tensor data.

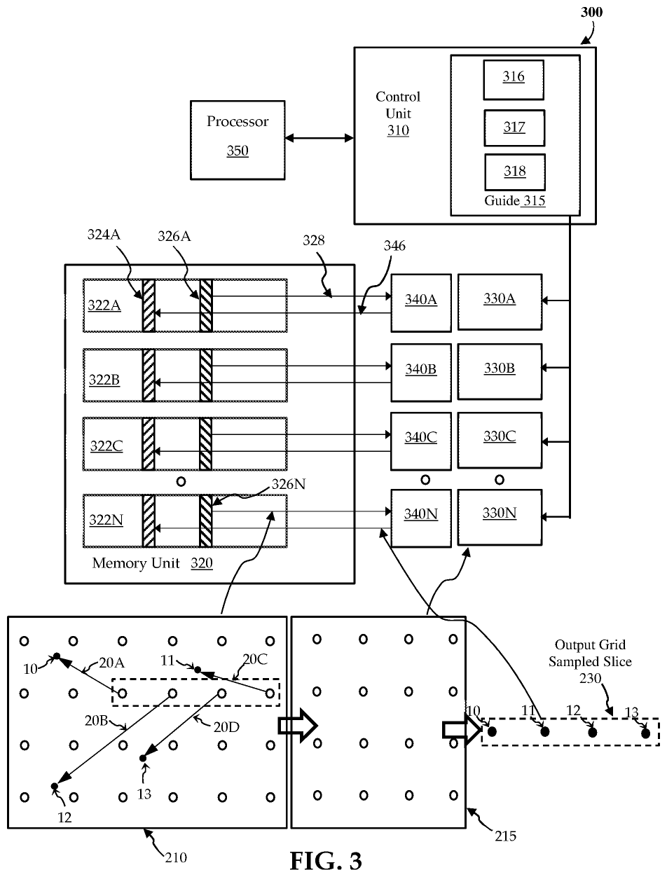

FIG. 3 provides a system block diagram 300 of semiconductor logic blocks configured to perform tensor transforms on customized digital hardware. The system is composed of a processor 350, a control unit 310, a memory unit 320, computational logic 330A-330N, and memory sequencer 340A-340N.

The processor 350 can provide high-level control and generate one or more guides 315. The guide generation can include setting the dimensions over which a tensor operator will be applied, the generation of one or more source tensor slice addresses 316, the generation of one or more indexes 317 associated with the source tensor slices, and the computation of interpolation weights 318. The processor 350 can be a digital signal processor, a microprocessor, a neural processor, or other customized computational logic suitable for the above-mentioned functions.

The control unit 310 includes the microelectronics required to control the data flow for the tensor interpolation of source tensor slices 316 based on the index values 317 and the interpolation weights 318. This guide 315 can be stored in memory local to the control unit 315, which can be cache memory. The control unit 310 can include DMA sequencers and a flow sequencer for moving data source slice data 326A-326N from the memory unit 320 to computational logic blocks 330A-330N along with the interpolation weights 318 to generate the output tensor 326A-326N. The generated interpolation weights 318 can vary for each index 317.

The control unit 310 sequencer provides the control over the memory unit 320 through the memory controllers 340A-340N for reading tensor slices 326A-326N, controlling the computation blocks 330A-330N, and generating the interpolated output tensor values 324A-324N that can be stored back into the memory unit 320.

The memory unit 320 includes a plurality of memory blocks 322A-322N. These blocks include the source tensor, of which the source tensor slices 326A-326N are a subset. The output interpolated tensor is stored back into the memory unit 320. The memory unit 320 can be configured to receive a plurality of memory addresses in parallel and provide a plurality of source data slice elements in parallel. Further, the memory unit can be configured to receive a single address and provide a pipelined sequence of source tensor data where other dimensions of the source tensor data are at a known offset from the previous address.

The computational blocks 330A-330N receive the source data slice data and interpolate the index values 317 based on the interpolation weights 318 to generate the output interpolate tensor data 324A-324N. These computational blocks 330A-330N can be limited to multiplying and adding. For an image or a two-dimensional tensor, circuitry for four multiply and add is required. For higher dimension tensor, more multiply and add circuitry is required.

The image blocks 210, 215 and 230 provide an example of how the data flows through the system 300. Image data 210 is stored in memory 326N which processed to determine the source slices 215 required for interpolation the output image slice 230. The sources slices 215 are received by the computational blocks 330A-330N where they are scaled by the weights 318 and summed. The resulting output tensor 230 is stored back into the memory unit 324A-324N.

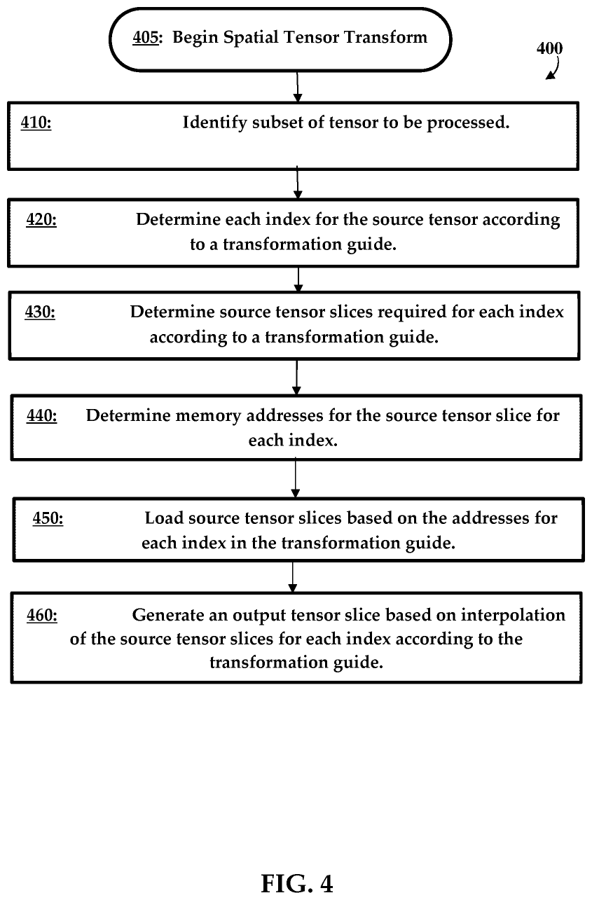

FIG. 4 shows a flow chart 400 for performing a spatial tensor transformation. The process begins at step 405 and can include any required initialization and configuration of hardware.

In step 210, an area of interest within a source tensor is identified for processing. If the source tensor is a two-dimensional image, the area of interest would include the part of the image that was to be processed. For example, a character in a text document image might need to be rotated. The area of interest might just be a shape around the character. This information can be stored as part of the transformation guide.

In step 420, the index for the transformed tensor is determined. The index is the data points after the tensor operator processes the data in the area of interest in the source tensor. The

In step 430, a determination of the source tensor slices required for each index is determined. These are slices of tensor data required for interpolating the source tensor, potentially an image, to the output tensor. The required tensor data are the source tensor slices that can contain data for multiple indexes, including a transformed tensor slice.

In step 440, a memory address is determined for each source tensor slice for each index. In some embodiments, the memory and the controller are structured so that the memory for one or more slice can be accessed with a single address reference. Further, the reading of the memory data can be pipelined. In a further embodiment, the memory can simultaneously receive multiple memory addresses and provide simultaneous reads of data.

In step 450, the data associated with each tensor slice associated with a single memory address can be used to load the source tensor slice associated with each index in the transformation guide. In some embodiments, the data can be read into a memory cache.

In step 460, an output tensor is generated. The generation of the output tensor is performed according to an associated transformation guide. In one embodiment, the transformation guide contains only the transform to be performed. Such a case would be for transforms that do not generate indexes and grid sampling weights. For example, the down or up-sampling does not always generate index values that require interpolation.

In another embodiment, an output tensor is generated from one or more guides. The guide can contain information regarding the transform to be used, the number of dimensions in the tensor, the coordinates of the space in the source tensor to be transformed, defining a tensor slice, which dimensions in the tensor are to be subject to the transform, indexes for the slice and interpolation weights for interpolating the indexes.

The corresponding structures, materials, acts, and equivalents of all means or step plus function elements in the claims below are intended to include any structure, material, or act for performing the function in combination with other claimed elements as specifically claimed. The description of the present technology has been presented for the purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods and apparatus (systems) according to embodiments of the present technology.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in an embodiment,” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms, and a plural term may include its singular form. Similarly, a hyphenated term (e.g., “on-demand”) may occasionally be interchangeably used with its non-hyphenated version (e.g., “on-demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments, the “means for” is expressed in terms of a mathematical formula, prose, or as a flow chart or signal diagram.

The terminology used herein is for the purpose of describing particular embodiments only and is not intended to be limiting of the invention. As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for performing spatial tensor transforms on a customize digital processor unit comprising:
determine source tensor slices required for each index according to a transformation guide;
determine memory addresses for the source tensor slices for each index;
loading from memory, using a single memory address, the source tensor slices based on the addresses for each index in the transformation guide; and
generating an output tensor slice based on interpolation of the source tensor slices for each index according to the transformation guide.

2. The method of claim 1, wherein the transformation guide includes a tensor operator for generating the output tensor slice.

3. The method of claim 2, wherein the plurality of values from the source tensor slice are read in a single pipeline cycle.

4. The method of claim 1, wherein multiple memory addresses are provided in parallel to the memory to simultaneously load the required source tensor slice.

5. The method of claim 1, wherein the loading the required source tensor slice for interpolation is through a cache.

6. The method of claim 1, further comprising determining each index for the source tensor according to a transformation guide.

7. The method of claim 6, wherein the determining each index according to a transformation guide implements a spatial transform that includes rotation, scaling, up-sampling, down-sampling, perspective, and distortion.

8. The method of claim 1, wherein the source tensor slices are comprised of a plurality of pixels in one or more dimensions.

9. The method of claim 1, wherein the interpolation includes linear, bilinear, cubic, and N-dimension interpolation.

10. The method of claim 1, wherein the interpolation is based on weights for each of the source tensor slices, the weights and being a function of the distance between the index and each source tensor slice.

11. The method of claim 1, wherein the transformation guide is common across multiple source tensor dimensions.

12. A system for performing tensor transforms on customized digital hardware comprising:
a plurality of computational blocks;
a control unit configured to:
read a source tensor index according to a transformation guide;
determine a single memory address for each source slice in a source tensor index according to a transformation guide;
loading the source slices based on the single memory address for each source slice; and
generate an output tensor based on interpolation of the source slices.

13. The system of claim 12, further comprising the step of the control units controlling the plurality of computational blocks to generate the indexes and according to the transformation guide and generate the interpolation weights according to a transformation guide.

14. The system of claim 13, wherein the tensor transform generate indexes for are for a spatial transform that includes rotation, scaling, up-sampling, down-sampling, perspective, and distortion.

15. The system of claim 13, wherein the control unit controls synchronously multiple computational blocks to generated the index and interpolation weights.

16. The system of claim 12, wherein the loading of the source slices is into a cache.

17. The system of claim 16, wherein the generating the output tensor slice based on interpolation is through data read through a cache.

18. The system of claim 12, wherein the transformation guide includes a tensor operator for generating the output tensor slice.

19. The system of claim 18, wherein the memory subsystem can simultaneously process multiple memory addresses to load the source tensor slices.

20. The system of claim 12, wherein the transformation guide is common across multiple source tensor dimensions.
